(19) United States
(12) Patent Application Publication
(10) Pub. No.: US 2026/0359029 A1
(43) Pub. Date: Nov. 12, 2026

(54) CXL MEMORY DEVICE FIRMWARE UPDATE SYSTEM

(71) Applicant: Dell Products L.P., Round Rock, TX (US)

(72) Inventors: Raveendra Reddy Padala, Bangalore (IN); Rama Rao Bisa, Bangalore (IN); Abhishek Ramachandra Manganawar, Bangalore (IN); Darshan Hebbar, Sagara (IN); Janardhan Venkata Sathya Narayana, Bangalore (IN); Manjunath Alaghatta Marulappa, Bangalore (IN); Pavan Kumar Gavvala, Bangalore (IN)

(21) Appl. No.: 19/199,509

(22) Filed: May 6, 2025

(51) Int. Cl. G06F 8/65; G06F 13/42

(52) U.S. Cl. CPC G06F 8/65; G06F 13/4221; G06F 2213/0026

(57) ABSTRACT

A CXL memory device firmware update system includes a CXL switch device that configures a first host device and second host devices to use CXL memory devices. The first host device identifies firmware used by each of the CXL memory devices and, in response, identifies a firmware update for a subset of the CXL memory devices. The first host device instructs the CXL switch device to reconfigure the subset of the CXL memory devices that are configured for use by second host device(s) to being configured for use by the first host device to provide the firmware update on the subset of the CXL memory devices. The first host device then receives firmware update activation confirmations from the subset of the CXL memory devices and, in response, instructs the CXL switch device to restore configuration of the subset of the CXL memory devices for use by the second host device(s).

### BACKGROUND

The present disclosure relates generally to information handling systems, and more particularly to updating firmware for CXL memory devices used by information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, sometimes utilize external memory systems for the storage of their data. For example, Compute eXpress Link (CXL) memory devices may be used by a host device (e.g., the server devices discussed above) in situations where the memory and/or IO needs of the host device are not satisfied. As will be appreciated by one of skill in the art in possession of the present disclosure, CXL technologies and protocols enable access to a logical memory space provided by CXL memory devices as if they were present in the host device, and may include Type 1 CXL memory devices that provide a fully coherent cache and that are often used with accelerator devices (e.g., Smart Network Interface Controllers (SmartNICs), cache coherent devices, and other accelerator devices) with no local memory for low-latency and compute offload tasks such as compression, encryption, and network processing; Type 2 CXL memory devices that provide relatively high-bandwidth memory and that are often used with accelerator devices (Graphics Processing Units (GPUs), Field Programmable Gate Arrays (FPGAs), Artificial Intelligence (AI) accelerators, and other accelerator devices) with local memory for high bandwidth and low latency memory sharing while maintaining cache coherence between the accelerator device and Central Processing Unit (CPU) memory; and Type 3 memory devices that operate as expanded or pooled memory for the host device and that may be provided by Dynamic Random Access Memory (DRAM), CXL-based Non-Volatile Dual Inline Memory Modules (NVDIMMs) and/or other persistent memory, pooled memory modules, and/or other memory devices to allow scalability in memory-intensive applications such as large databases, AI workloads, and cloud computing.

However, the use of external memory systems like the CXL memory systems described above raises a number of issues. For example, in a conventional CXL memory system, only a host device that is configured to use a CXL memory device will be capable of interacting with that CXL memory device to perform CXL memory device tasks. As such, firmware updates for CXL memory devices must be performed by the host device they are configured to operate with, and each host device that is configured to use CXL memory device(s) is responsible for updating the firmware for those CXL memory device(s).

As will be appreciated by one of skill in the art in possession of the present disclosure, performing conventional firmware updates for CXL memory devices in such a manner can result in the redundant performance of the same firmware update operations by different host devices (e.g., a firmware update for CXL memory devices used by different host devices must be performed for those CXL memory devices by each of those host devices). Furthermore, such conventional firmware updates for CXL memory devices can result in firmware inconsistencies that can lead to degraded performance and/or other performance issues, communication errors and/or other compatibility issues, inconsistent CXL memory device behavior, CXL memory system instabilities, and/or other operational challenges if, for example, all of the host devices do not update their respective CXL memory devices to the same firmware. Further still, such conventional firmware updates for CXL memory devices can present security issues if, for example, a host device is compromised and performs a malicious firmware update that provides unauthorized firmware on CXL memory device(s).

Accordingly, it would be desirable to provide a CXL memory device firmware update system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a management engine that is configured to: identify respective firmware used by each of a plurality of Compute eXpress Logic (CXL) memory devices that are coupled to the processing system via a CXL switch device that configures the IHS and each of a plurality of host devices to use the plurality of CXL memory devices; identify, based on the respective firmware used by each of the plurality of CXL memory devices, a firmware update for a subset of the plurality of CXL memory devices; instruct the CXL switch device to reconfigure the subset of the plurality of CXL memory devices that are configured for use by at least one of the plurality of host devices to being configured for use by the IHS; provide, in response to the CXL switch device reconfiguring the subset of the plurality of CXL memory devices that are configured for use by at least one of the plurality of host devices to being configured for use by the IHS, the firmware update on the subset of the plurality of CXL memory devices; and receive, from each of the subset of the plurality of CXL memory devices, a firmware update activation confirmation and, in response, instruct the CXL switch device to restore configuration of the subset of the plurality of CXL memory devices for use by the at least one of the plurality of host devices.

### BRIEF DESCRIPTION OF THE DRAWINGS

FIG. 1 is a schematic view illustrating an embodiment of an Information Handling System (IHS).

FIG. 2 is a schematic view illustrating an embodiment of a CXL memory device firmware update system that may be provided according to the teachings of the present disclosure.

FIG. 3 is a flow chart illustrating an embodiment of a method for updating firmware for CXL memory devices.

FIG. 4 is a schematic view illustrating an embodiment of host device/CXL memory device links provided in the CXL memory device firmware update system of FIG. 2 during the method of FIG. 3.

FIG. 5 is a schematic view illustrating an embodiment of the CXL memory device firmware update system of FIG. 2 operating during the method of FIG. 3.

FIG. 6 is a schematic view illustrating an embodiment of the CXL memory device firmware update system of FIG. 2 operating during the method of FIG. 3.

FIG. 7 is a schematic view illustrating an embodiment of the CXL memory device firmware update system of FIG. 2 operating during the method of FIG. 3.

FIG. 8A is a schematic view illustrating an embodiment of the CXL memory device firmware update system of FIG. 2 operating during the method of FIG. 3.

FIG. 8B is a schematic view illustrating an embodiment of host device/CXL memory device links provided in the CXL memory device firmware update system of FIG. 2 during the method of FIG. 3.

FIG. 9 is a schematic view illustrating an embodiment of the CXL memory device firmware update system of FIG. 2 operating during the method of FIG. 3.

FIG. 10 is a schematic view illustrating an embodiment of the CXL memory device firmware update system of FIG. 2 operating during the method of FIG. 3.

FIG. 11 is a schematic view illustrating an embodiment of the CXL memory device firmware update system of FIG. 2 operating during the method of FIG. 3.

FIG. 12A is a schematic view illustrating an embodiment of the CXL memory device firmware update system of FIG. 2 operating during the method of FIG. 3.

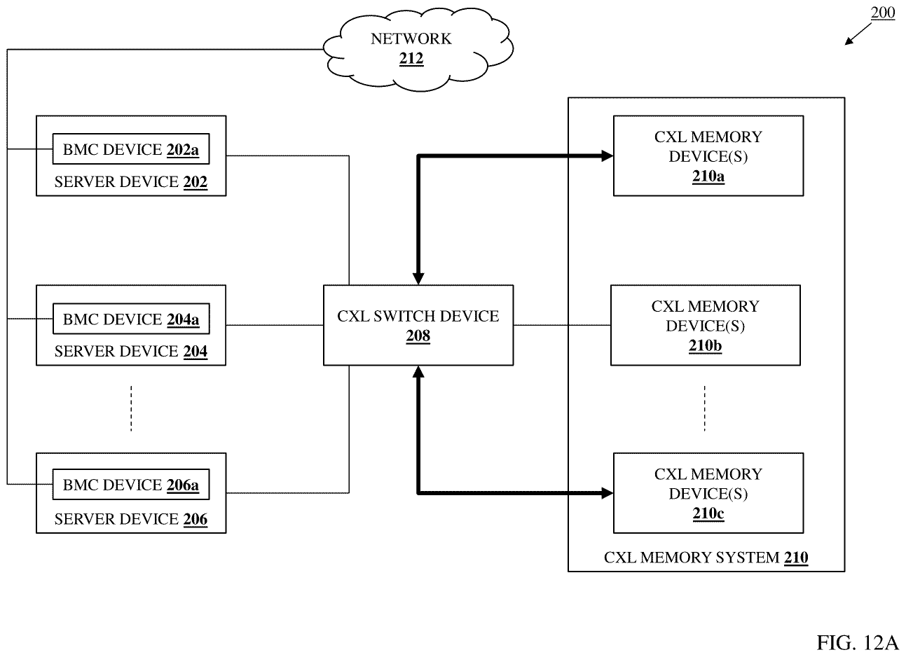

FIG. 12B is a schematic view illustrating an embodiment of host device/CXL memory device links provided in the CXL memory device firmware update system of FIG. 2 during the method of FIG. 3.

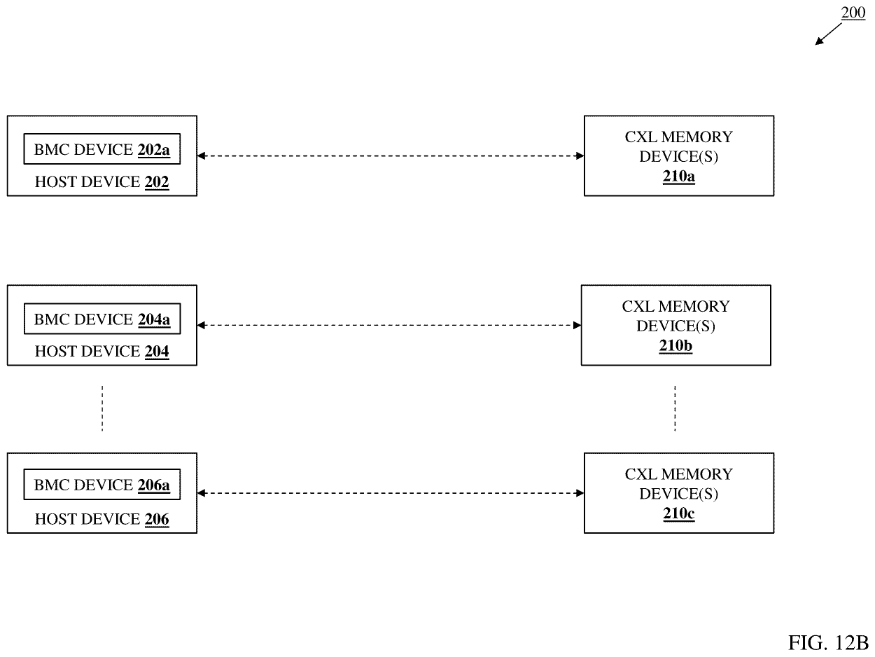

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

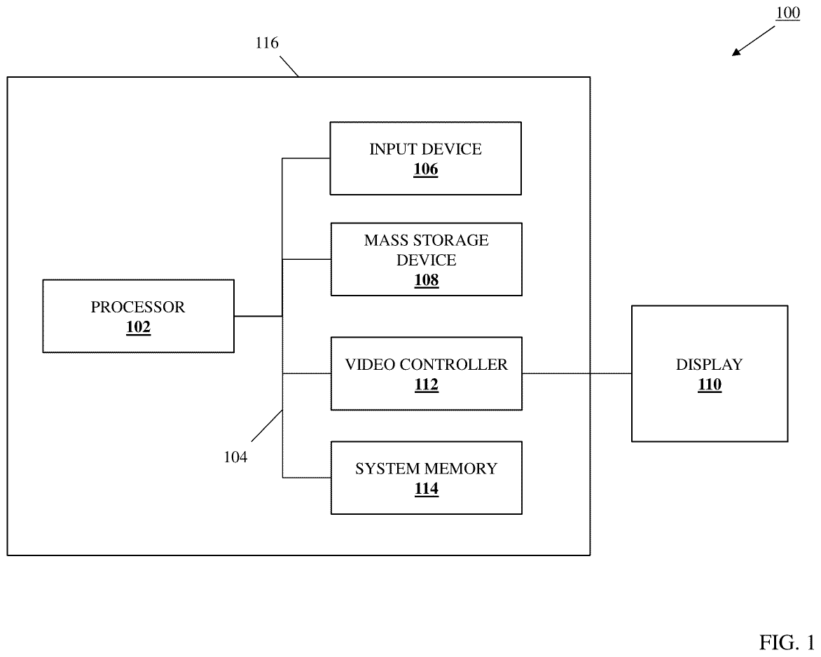

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

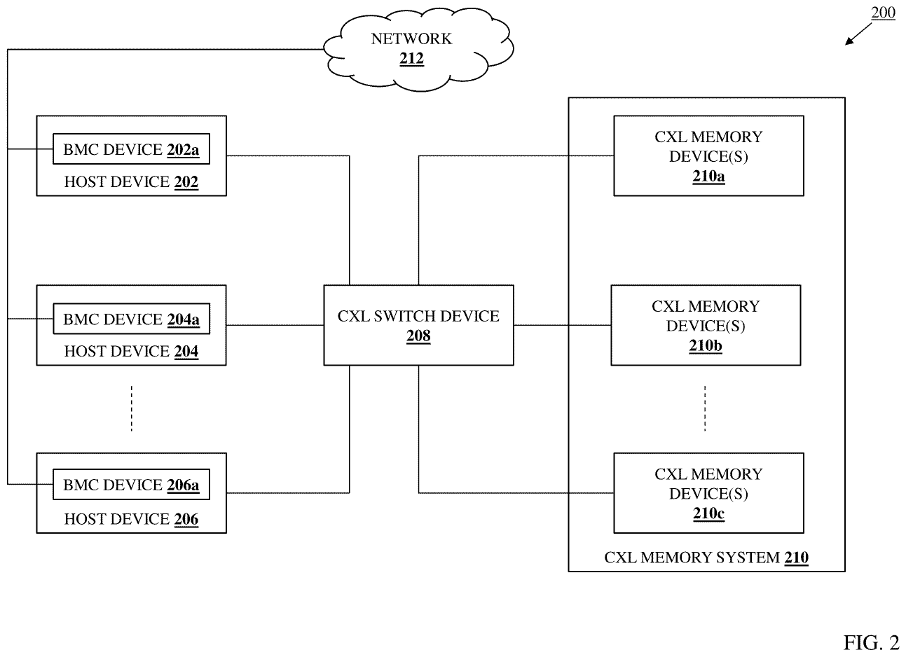

Referring now to FIG. 2, an embodiment of a Compute eXpress Logic (CXL) memory device firmware update system 200 is illustrated that may be provided according to the teachings of the present disclosure. In the illustrated embodiment, the CXL memory device firmware update system 200 includes a plurality of host devices 202, 204, and up to 206. In an embodiment, any of each of the host devices 202-206 may be provided by the IHS 100 discussed above with reference to FIG. 1, and/or may include some or all of the components of the IHS 100, and in the specific examples below are described as being provided by server devices. However, while illustrated and discussed as being provided by server devices, one of skill in the art in possession of the present disclosure will recognize that host devices provided in the CXL memory device firmware update system 200 may include any computing devices that may be configured to operate similarly as the host devices 202-206 discussed below.

In the embodiments described below, the CXL memory device firmware update functionality of the host devices 202, 204, and up to 206 is illustrated and described as being performed by management subsystems in those host devices that are provided by respective Baseboard Management Controller (BMC) devices 202a, 204a, and up to 206a. For example, the BMC devices 202a, 204a, and up to 206a in the host devices 202, 204, and up to 206, respectively, may be provided by integrated DELL® Remote Access Controller (iDRAC) devices included in server devices available from DELL® Inc. of Round Rock, Texas, United States, as well as any other BMC devices known in the art. As will be appreciated by one of skill in the art in possession of the present disclosure, each BMC device 202a-206a may include a processing system and a memory system that is coupled to the processing system and that includes instruction that, when executed by the processing system, cause the processing system to perform the functionality of the BMC devices and host devices described below. However, while the CXL memory device firmware update functionality of the host devices 202-206 is described below as being performed by management subsystems such as BMC devices, one of skill in the art in possession of the present disclosure will appreciate how the host devices 202-206 may perform the CXL memory device firmware update functionality discussed below using other techniques that will fall within the scope of the present disclosure as well.

Each of the host devices 202-206 are coupled via a CXL switch device 208 to a CXL memory system 210 that includes one or more CXL memory devices 210a, one or more CXL memory devices 210b, and up to one or more CXL memory devices 210c. As will be appreciated by one of skill in the art in possession of the present disclosure, the CXL switch device 208 is configured to allow the host devices 202-206, their BMC devices 202a-206a, the CXL memory devices 210a-210c via the CXL interconnect standard, operating as a central hub to allow the host devices 202a-206a to utilize the CXL memory device 210a-210c with relatively low latency and relatively high bandwidth. As such, the CXL switch device 208 may include a processing system and a memory system that includes instruction that, when executed by the processing system, cause the processing system to provide a CXL switch engine (e.g., the “fabric manager”) that is configured to perform the functionality of the CXL switch devices discussed below.

For example, the CXL switch engine in the CXL switch device 208 may be configured to enable multi-host device connectivity to the CXL memory system 210 (supporting multiple processing system/accelerator device connectivity to the CXL memory devices 210a-210c), memory pooling of the CXL memory system 210 (e.g., enabling dynamic sharing of the CXL memory devices 210a-210c by the host devices 202-206), relatively fast cache-coherent access by the host devices 202-206 to data stored on the CXL memory system 210, Peripheral Component Interconnect express (PCIe) physical layer access by the host devices 202-206 to the CXL memory devices 210a-210c for relatively high speed data transfers between the host devices 202-206 and the CXL memory devices 210a-210c, workload scalability (supporting relatively large-scale Artificial Intelligence, Machine Learning, and High Performance Computing workloads), and/or other CXL switch device functionality known in the art.

As discussed above, the CXL memory devices 210a-210c may include Type 1 CXL memory devices that provide a fully coherent cache and that are often used with accelerator devices (e.g., Smart Network Interface Controllers (SmartNICs), cache coherent devices, and other accelerator devices) with no local memory for low-latency and compute offload tasks such as compression, encryption, and network processing; Type 2 CXL memory devices that provide relatively high-bandwidth memory and that are often used with accelerator devices (Graphics Processing Units (GPUs), Field Programmable Gate Arrays (FPGAs), Artificial Intelligence (AI) accelerators, and other accelerator devices) with local memory for high bandwidth and low latency memory sharing while maintaining cache coherence between the accelerator device and Central Processing Unit (CPU) memory; Type 3 memory devices that operate as expanded or pooled memory for the host device and that may be provided by Dynamic Random Access Memory (DRAM), CXL-based Non-Volatile Dual Inline Memory Modules (NVDIMMs) and/or other persistent memory, pooled memory modules, and/or other memory devices to allow scalability in memory-intensive applications such as large databases, AI workloads, and cloud computing; as well as other CXL memory device types that would be apparent to one of skill in the art in possession of the present disclosure.

One of skill in the art in possession of the present disclosure will appreciate how the embodiments illustrated and described below provide the CXL memory system 210 as a “Just a Bunch Of Memory” (JBOM) system that may include a chassis that houses the CXL memory devices 210a-210c, and that may be configured to be housed in a rack with the host devices 202-206. However, while a JBOM system that provides the CXL memory system 210 is illustrated and described below, one of skill in the art in possession of the present disclosure will appreciate how the CXL memory system 210 may be provided in a variety of manners that will fall within the scope of the present disclosure as well.

As illustrated, the CXL memory device firmware update system 200 may include a network 212 that is coupled to the BMC devices 202a-206a in the host devices 202-206. For example, the network 212 may be a management network that is accessible by the BMC devices 202a-206a in the host devices 202-206 to identify and retrieve the firmware updates discussed above, and thus may provide access to CXL memory device provider systems that generate and provide those firmware updates for the CXL memory devices 210a-210c, although one of skill in the art in possession of the present disclosure will appreciate how the network 212 may be utilized in other manners (e.g., by a user to provide the firmware updates to the BMC devices 202a-206a in the host devices 202-206, respectively) while remaining within the scope of the present disclosure as well. However, while a specific CXL memory device firmware update system 200 has been illustrated and described, one of skill in the art in possession of the present disclosure will recognize that the CXL memory device firmware update system of the present disclosure may include a variety of components and component configurations for providing the CXL memory device firmware update functionality described below while remaining within the scope of the present disclosure as well.

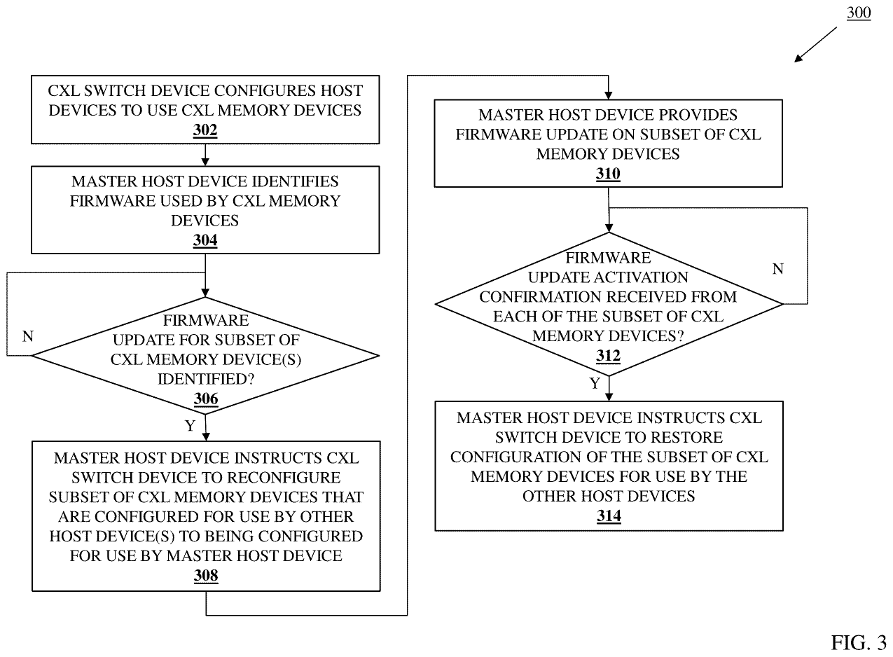

Referring now to FIG. 3, an embodiment of a method 300 for updating firmware for CXL memory devices is illustrated. As discussed below, the systems and methods of the present disclosure provide for the updating of firmware on CXL memory devices via a master host device that is one of a plurality of host devices that are configured to use those CXL memory devices. For example, the CXL memory device firmware update system of the present disclosure may include a CXL switch device that configures a first host device and second host devices to use CXL memory devices. The first host device identifies firmware used by each of the CXL memory devices and, in response, identifies a firmware update for a subset of the CXL memory devices. The first host device then instructs the CXL switch device to reconfigure the subset of the CXL memory devices that are configured for use by second host device(s) to being configured for use by the first host device to provide the firmware update on the subset of the CXL memory devices. The first host device then receives firmware update activation confirmations from the subset of the CXL memory devices and, in response, instructs the CXL switch device to restore configuration of the subset of the CXL memory devices for use by the second host device(s).

As such, the CXL memory device firmware update system of the present disclosure allows firmware on CXL memory devices to be updated without the redundant performance of the same firmware update operations by different host devices, eliminates security issues present in conventional CXL memory device firmware update systems, reduces downtime needed to perform CXL memory device firmware updates, and prevents firmware inconsistencies that can lead to degraded performance and/or other performance issues, communication errors and/or other compatibility issues, inconsistent CXL memory device behavior, CXL memory system instabilities, and/or other operational challenges.

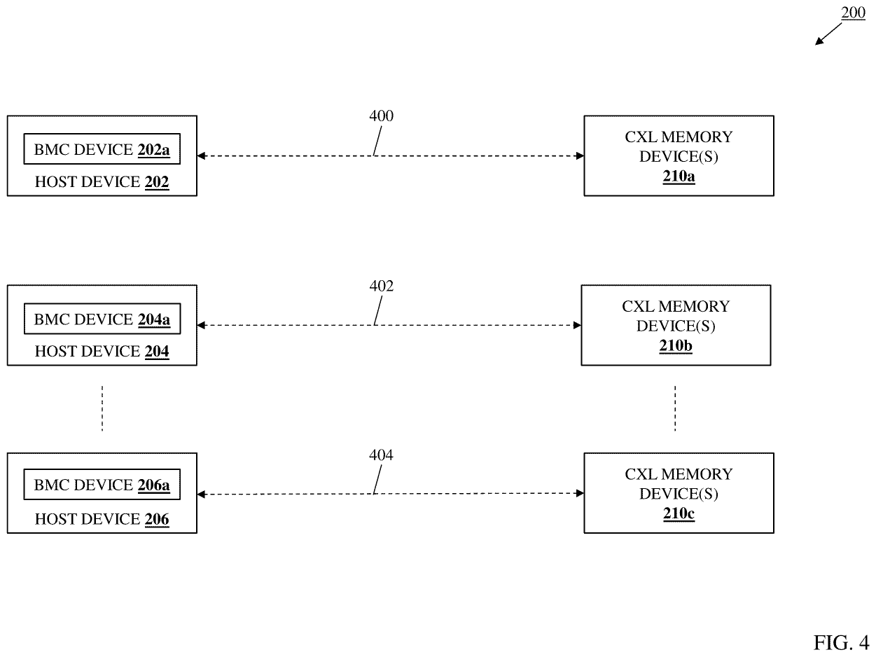

The method 300 begins at block 302 where a CXL switch device configures host devices to use CXL memory devices. With reference to FIG. 2, in an embodiment of block 302, the CXL switch device 208 may configure the host devices 202-206 to use the CXL memory devices 210a-210c in the CXL memory system 210. For example, FIG. 4 illustrates how the CXL switch device 208 may be configured to provide a communication link 400 between the host device 202 and the CXL memory device(s) 210a that configures the host device 202 to use the CXL memory device(s) 210a, a communication link 402 between the host device 204 and the CXL memory device(s) 210b that configures the host device 204 to use the CXL memory device(s) 210b, and up to a communication link 404 between the host device 206 and the CXL memory device(s) 210c that configures the host device 206 to use the CXL memory device(s) 210c.

As will be appreciated by one of skill in the art in possession of the present disclosure, the communication links 400-404 may be configured in the CXL switch device using any of a variety of CXL interconnect techniques known in the art that operate to allocate CXL memory resources provided by the CXL memory devices 210a-210c in the CXL memory system 210 to the host devices 202-206. Furthermore, while each of the host devices 202-206 is illustrated as being configured to use separate CXL memory devices 210a-210c, respectively, one of skill in the art in possession of the present disclosure will appreciate how the allocation of CXL memory resources provided by the CXL memory devices 210a-210c in the CXL memory system 210 to the host devices 202-206 may include configuring multiple host devices to use different portions of a CXL memory device (e.g., configuring a first host device to utilize a first memory address range provided by a CXL memory device, configuring a second host device to utilize a second memory address range provided by that CXL memory device, and so on). Thus, while a specific example of the configuration of host devices to use CXL memory devices is illustrated and described below, one of skill in the art in possession of the present disclosure will appreciate how host devices may be configured to use CXL memory devices in any of a variety of manners while remaining within the scope of the present disclosure.

The method 300 then proceeds to block 304 where a master host device identifies firmware used by the CXL memory devices. In some embodiments, during or prior to the method 300, one of the host devices 202-206 may be designated, elected, or otherwise configured to provide a master host device that operates as a master firmware update host for the plurality of host devices 202-206. In one example, a network administrator or other user may designate the BMC device 204a in the host device 204 as the master firmware update host in order to configure the host device 204 to provide the master host device for the plurality of host devices 202-206. In another example, the host devices 202-206 may utilize any of a variety of election techniques known in the art (e.g., based on Media Access Control (MAC) addresses) to elect the BMC device 204a in the host device 204 as the master firmware update host in order to configure the host device 204 to provide the master host device for the plurality of host devices 202-206. However, while two specific examples of the configuration of the host device 204 as the master host device have been provided, one of skill in the art in possession of the present disclosure will appreciate how any of the host devices may be configured as the master host device using any of a variety of techniques that will fall within the scope of the present disclosure.

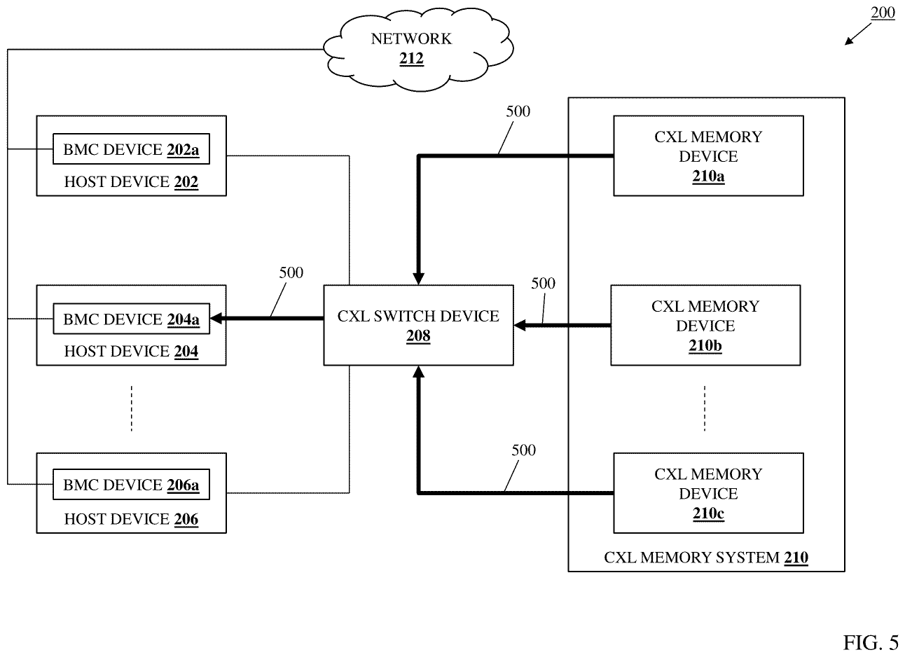

With reference to FIG. 5, in an embodiment of block 304, the BMC device 204a in the host device 204 (which in this example was configured as the master firmware update host to configure the host device 204 as the master host device) may perform CXL memory device firmware identification operations 500 that may include discovering each of the CXL memory devices 210a-210c in the CXL memory system 210 via the CXL switch device 208, identifying the firmware currently being utilized by each of the CXL memory devices 210a-210c in the CXL memory system 210 (e.g., identifying a firmware version utilized by each of the CXL memory devices 210a-210c in the CXL memory system 210, and/or retrieving any other information about the CXL memory devices 210a-210c in the CXL memory system 210 that would be apparent to one of skill in the art in possession of the present disclosure. As such, following block 304, a database provided by a storage subsystem that is included in the BMC device 204a or that is otherwise accessible to the BMC device 204a may store CXL memory device firmware identification information that identifies the firmware being used by each of the CXL memory devices 210a-210c.

In some embodiments, the CXL memory devices identified at block 304 may be CXL memory devices provided by the same CXL memory device provider such that only CXL memory devices that are configured to utilize the same firmware update from that CXL memory device provider are identified. As will be appreciated by one of skill in the art in possession of the present disclosure, the identification of CXL memory devices provided by the same CXL memory device provider may allow the method 300 to perform the firmware update discussed below using a single firmware update provided by that CXL memory device provider, and for CXL memory systems including homogenous CXL memory devices (i.e., CXL memory devices provided by the same CXL memory device provider), may be utilized to ensure that each of the CXL memory devices in that CXL memory system use the same firmware.

However, for CXL memory systems including CXL memory devices provided by different CXL memory device providers, one of skill in the art in possession of the present disclosure will appreciate how different firmware updates provided by different CXL memory device providers may be identified and use to perform firmware updates for those CXL memory devices while remaining within the scope of the present disclosure as well. For example, in a CXL memory system including heterogeneous CXL memory devices (i.e., CXL memory devices provided by different CXL memory device providers), the method 300 may be performed to provide firmware updates on each set of CXL memory devices provided by the same CXL memory device provider “one CXL memory device provider/firmware update at a time”.

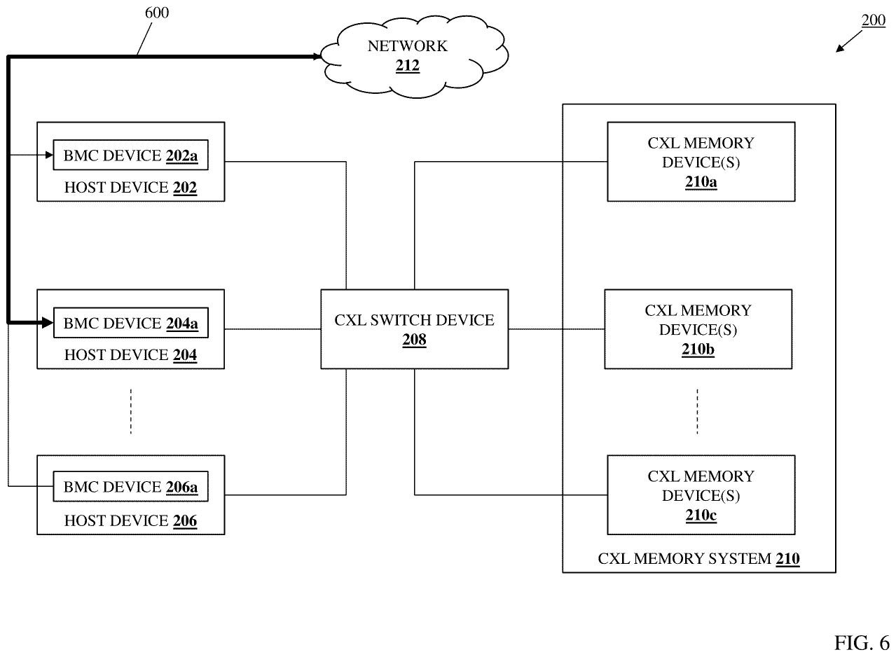

The method 300 then proceeds to decision block 306 where it is determined whether a firmware update for a subset of the CXL memory devices is identified. With reference to FIG. 6, in an embodiment of decision block 306, the BMC device 204a in the host device 204 (which in this example was configured as the master firmware update host to configure the host device 204 as the master host device) may perform CXL memory device firmware update identification operations 600 that may include determining whether a firmware update is available for any of the CXL memory devices 210a-210c via the network 212, which may include comparing version(s) of firmware that are available for the CXL memory devices 210a-210c to the firmware versions identified for those CXL memory devices 210a-210c at block 304, and/or performing any other firmware update identification operations that would be apparent to one of skill in the art in possession of the present disclosure.

In one example, the CXL memory device firmware update identification operations 600 may include the BMC device 204a determining whether a CXL memory device provider of any of the CXL memory devices 210a-210c has made a firmware update available for those CXL memory devices that updates the firmware that was identified for those CXL memory devices 210a-210c at block 304. In another example, the CXL memory device firmware update identification operations 600 may include the BMC device 204a determining whether a network administrator or other user has provided a firmware update for any of the CXL memory devices 210a-210c via the network to the BMC device 204a that updates the firmware that was identified for those CXL memory devices 210a-210c at block 304. However, while two specific examples have been described, one of skill in the art in possession of the present disclosure will appreciate how firmware updates for CXL memory devices may be identified using other techniques that will fall within the scope of the present disclosure as well.

If, at decision block 306, no firmware update is identified for a subset of the CXL memory devices, the method 300 returns to block 306. As such, the method 300 may loop such that the BMC device 204a in the host device 204 continues to perform the CXL memory device firmware update identification operations 600 to determine whether a firmware update is available for any of the CXL memory devices 210a-210c via the network 212 until a firmware update for any of the CXL memory devices 210a-210c is identified.

If, at decision block 306, a firmware update is identified for a subset of the CXL memory devices, the method 300 proceeds to block 308 where the master host device instructs the CXL switch device to reconfigure the subset of CXL memory devices that are configured for use by one or more other host devices to being configured for use by the master host device. In a specific example, a network administrator or other user may have replace CXL memory devices in, and/or added CXL memory devices to, the CXL memory system 210 such that at least some of the CXL memory devices in the CXL memory system 210 include older or otherwise non-updated firmware, and thus at decision block 306 the BMC device 204a may identify a firmware update for those CXL memory devices. However, while a specific example has been provided, one of skill in the art in possession of the present disclosure will appreciate how firmware updates may for CXL memory devices may be identified in a variety of scenarios that will fall within the scope of the present disclosure. As discussed in further detail below, in some embodiments, the firmware updates of the present disclosure may be performed during a designated maintenance time period for the CXL memory system 210, while in other embodiments the firmware updates of the present disclosure may be “live” firmware updates performed in between periods of use of the CXL memory system 210 and its CXL memory devices 210a-210c.

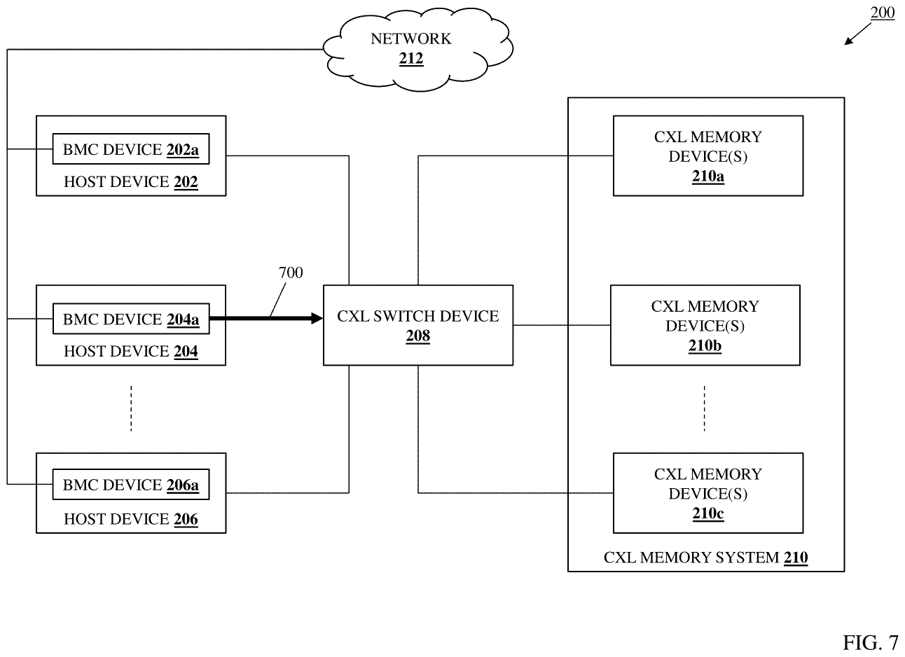

With reference to FIG. 7, in an embodiment of block 308 and continuing the example illustrated and discussed above with reference to FIG. 4, the BMC device 204a in the host device 204 (which in this example was configured as the master firmware update host to configure the host device 204 as the master host device) may perform CXL switch device reconfiguration instruction operations 700 that include generating and transmitting a reconfiguration instruction to the CXL switch device 208 to reconfigure the subset of CXL memory devices 210a and 210c that are configured for use by the host devices 202 and/or 206, respectively, to being configured for use by the host device 204.

In the specific example described below, the subset of CXL memory devices for which a firmware update is identified at decision block 306 are initially configured for use by the host device 202 and the host device 206, and thus at block 308 the CXL switch device reconfiguration instruction operations 700 include generating and transmitting a reconfiguration instruction to the CXL switch device 208 to reconfigure that subset of CXL memory devices 210a and 210c to being configured for use by the host device 204. As such, the reconfiguration instruction may include an instruction to reconfigure one or more of the CXL memory device(s) 210a (and in some cases, all of the CXL memory device(s) 210a) for which the firmware update was identified from being configured for use by the host device 202 to being configured for use by the host device 204, and to reconfigure one or more of the CXL memory device(s) 210c (and in some cases, all of the CXL memory device(s) 210c) for which the firmware update was identified from being configured for use by the host device 206 to being configured for use by the host device 204.

However, while a specific example has been provided in which the reconfiguration instruction includes an instruction to reconfigure one or more of the CXL memory device(s) 210a and one or more of the CXL memory device(s) 210c, one of skill in the art in possession of the present disclosure will appreciate how the reconfiguration instruction may only include an instruction to reconfigure one or more of the CXL memory device(s) 210a, or may only include an instruction to reconfigure one or more of the CXL memory device(s) 210c, while remaining within the scope of the present disclosure. In other words, the reconfiguration instruction will instruct the CXL switch device 208 to reconfigure any CXL memory devices for use by the host device 204 that 1) are configured for use by host devices other than the host device 204, and 2) for which a firmware update has been identified.

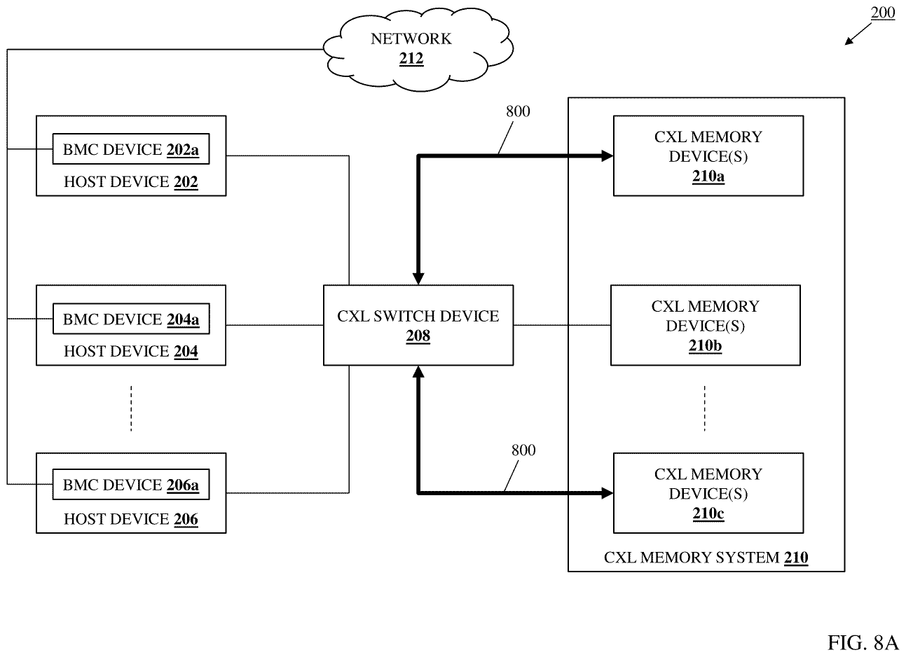

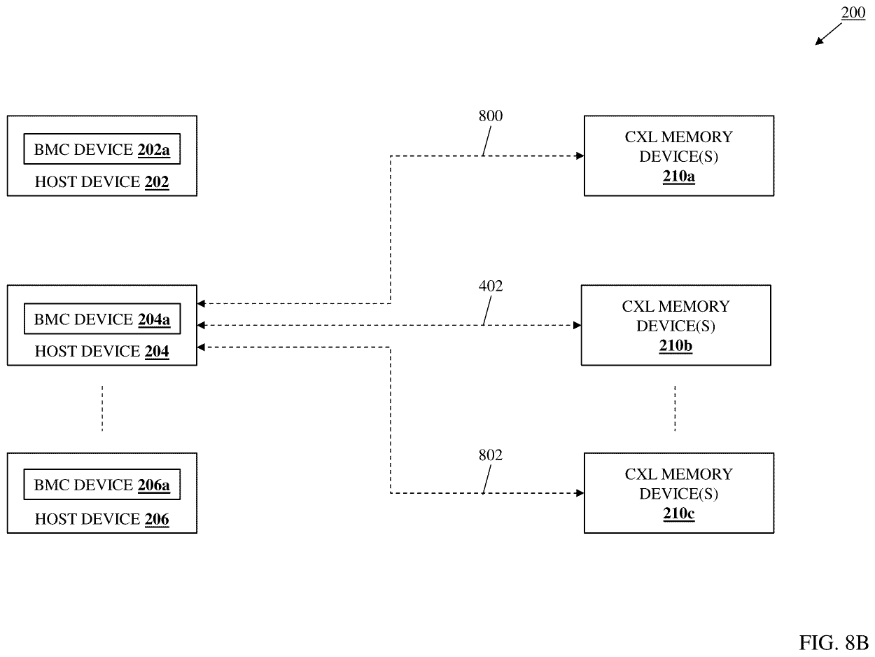

With reference to FIG. 8A, in an embodiment of block 308 and in response to receiving the reconfiguration instruction, the CXL switch device 208 may perform CXL memory device reconfiguration operations 800 that include reconfiguring the subset of CXL memory devices 210a and 210c for use by the host device 204. With reference to FIG. 8B, in a specific example, the subset of CXL memory devices for which a firmware update is identified at decision block 306 include one or more of the CXL memory devices 210a and one or more of the CXL memory devices 210c, and the reconfiguration operations 800 include the CXL switch device 208 reconfiguring itself by disconnecting the communication link 400 between the host device 202 and the CXL memory device(s) 210a and providing a communication link 800 between the host device 204 and those one or more CXL memory devices 210c, and disconnecting the communication link 404 between the host device 206 and the CXL memory device(s) 210c and providing a communication link 802 between the host device 204 and those one or more CXL memory devices 210c.

As such, the reconfiguration operations 800 may include reconfiguring one or more of the CXL memory device(s) 210a (and in some cases, all of the CXL memory device(s) 210a) for which the firmware update was identified from being configured for use by the host device 202 to being configured for use by the host device 204, and reconfiguring one or more of the CXL memory device(s) 210c (and in some cases, all of the CXL memory device(s) 210c) for which the firmware update was identified from being configured for use by the host device 206 to being configured for use by the host device 204.

Similarly as described above, while a specific example has been provided in which one or more of the CXL memory device(s) 210a and one or more of the CXL memory device(s) 210c are reconfigured for use by the host device 204, one of skill in the art in possession of the present disclosure will appreciate how the reconfiguration may only be performed for one or more of the CXL memory device(s) 210a, or may only be performed for one or more of the CXL memory device(s) 210c, while remaining within the scope of the present disclosure. In other words, the CXL switch device 208 will reconfigure any CXL memory devices for use by the host device 204 that 1) are configured for use by host devices other than the host device 204, and 2) for which a firmware update has been identified. As such, following block 308 and in the specific example illustrated in FIG. 8B, the host device 204 includes the communication link 402 to the CXL memory device(s) 210b, the communication link 800 to one or more of the CXL memory device(s) 210a for which the firmware update was identified, and the communication link 802 to one or more of the CXL memory device(s) 210a for which the firmware update was identified.

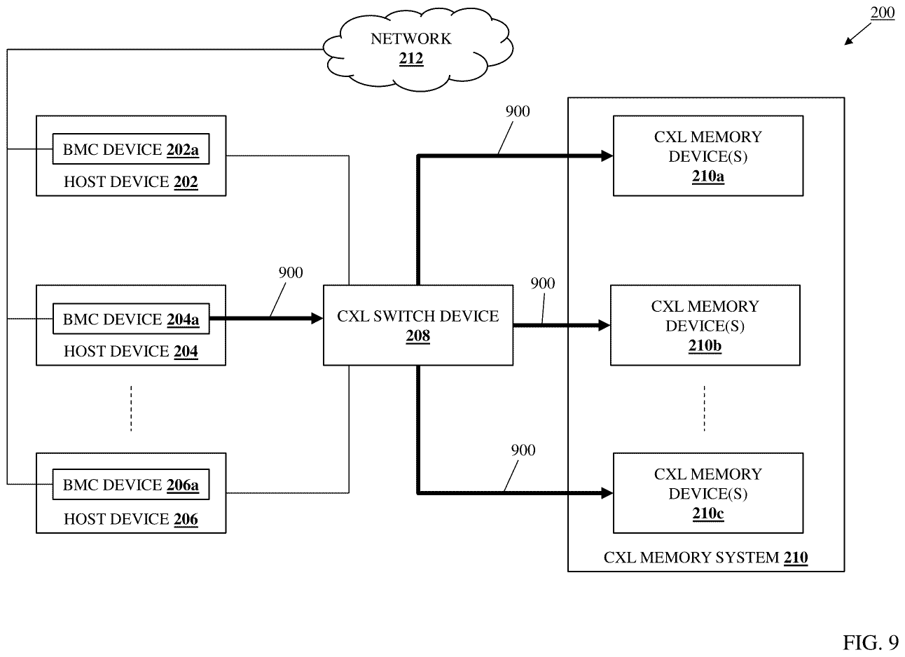

The method 300 then proceeds to block 310 where the master host device provides the firmware update on the subset of CXL memory devices. With reference to FIG. 9, in an embodiment of block 310, the BMC device 204a in the host device 204 (which in this example was configured as the master firmware update host to configure the host device 204 as the master host device) may perform CXL memory device firmware update operations 900 that may include providing the firmware update identified at decision block 306 on the subset of CXL memory devices 210a-210c for which that firmware update updates the firmware identified for those CXL memory devices at block 304. In a specific example, the CXL memory device firmware update operations 900 performed by the BMC device 204a may include the use of Peripheral Component Interconnect express (PCIe) Vendor Defined Messages (VDMs) to transmit the firmware update to the CXL memory devices 210a-210c, although other techniques for transmitting the firmware update will fall within the scope of the present disclosure as well. With reference to FIG. 8B, in the example illustrated in FIG. 9, the CXL memory device firmware update operations 900 include the BMC device 204a providing the firmware update to one of more of the CXL memory devices 210a via the communication link 800, to one of more of the CXL memory devices 210a via the communication link 402, and to one of more of the CXL memory devices 210c via the communication link 802.

However, while a specific example has been illustrated and described, one of skill in the art in possession of the present disclosure will appreciate how the firmware update may be provided at block 310 to any CXL memory device for which that firmware update updates the firmware that was identified for that CXL memory device at block 304, and thus may only be provided to one of more of the CXL memory devices 210a via the communication link 800, or may only be provided to one of more of the CXL memory devices 210a via the communication link 402, or may only be provided to one of more of the CXL memory devices 210c via the communication link 802. However, while specific examples have been provided, the provisioning of the firmware update to any other combination of the CXL memory devices 210a-210c is envisioned as falling within the scope of the present disclosure.

As discussed above, in some embodiments, the firmware update identified at decision block 306 may be provided by the same CXL memory device provider for their CXL memory devices, which allows the firmware update to be performed for the subset of CXL memory devices at block 310 using a single firmware update provided by that CXL memory device provider, and for CXL memory systems including homogenous CXL memory devices (i.e., CXL memory devices provided by the same CXL memory device provider), may be utilized to ensure that each of the CXL memory devices uses the same firmware.

However, for CXL memory systems including CXL memory devices provided by different CXL memory device providers, one of skill in the art in possession of the present disclosure will appreciate how different firmware updates provided by different CXL memory device providers may be provided on CXL memory devices provided by different CXL memory device providers while remaining within the scope of the present disclosure as well. For example, in a CXL memory system including heterogeneous CXL memory devices (i.e., CXL memory devices provided by different CXL memory device providers), some or all of the method 300 may be repeated to provide firmware updates on CXL memory devices “one CXL memory device provider at a time”.

The method 300 then proceeds to decision block 312 where it is determined whether a firmware update activation confirmation has been received from each of the subset of CXL memory devices. As will be appreciated by one of skill in the art in possession of the present disclosure, following the provisioning of the firmware update on the subset of CXL memory devices for which the firmware update was identified at block 304, the BMC device 204a in the host device 204 (which in this example was configured as the master firmware update host to configure the host device 204 as the master host device) may send an instruction (e.g., a “commit command”) to those CXL memory devices to activate (e.g., “commit”) that firmware update, which will cause those CXL memory devices to each verify the firmware update it received, and then perform activation operations to activate that firmware update and provide a firmware update activation confirmation to the BMC device 204a once those activation operations have been completed. As will be appreciated by one of skill in the art in possession of the present disclosure, during the “live” firmware updates described herein, the verification of the firmware update by the CXL memory devices may be performed “in the background” while those CXL memory devices are being used by their host devices.

As such, in an embodiment of decision block 312 and following the provisioning of the firmware update(s) at block 310, the BMC device 204a may monitor for firmware update activation confirmations from each of the CXL memory devices to which the firmware update was provided. If, at decision block 312, a firmware update activation confirmation has not been received from each of the subset of CXL memory devices, the method 300 returns to decision block 312. As such, the method 300 may loop such that the BMC device 204a continues to monitor for firmware update activation confirmations from each of the CXL memory devices to which the firmware update was provided until a firmware update activation confirmation has been received from each of those CXL memory devices.

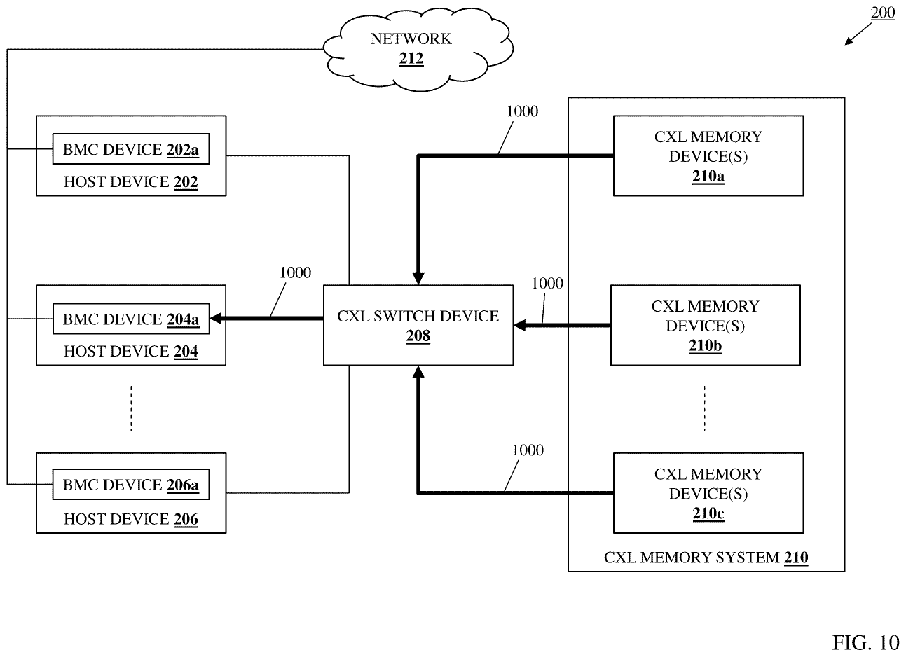

If, at decision block 312, a firmware update activation confirmation has been received from each of the subset of CXL memory devices, the method 300 proceeds to block 314 where the master host device instructs the CXL switch device to restore configuration of the subset of CXL memory devices for use by the one or more other host devices. With reference to FIG. 10, in an embodiment of decision block 312, the BMC device 204a in the host device 204 (which in this example was configured as the master firmware update host to configure the host device 204 as the master host device) may perform firmware update activation confirmation receiving operations 1000 that, in the illustrated example, include receiving a firmware update activation confirmation from each of the one or more of the CXL memory device(s) 210a, the one or more of the CXL memory device(s) 210b, and the one or more of the CXL memory device(s) 210c to which the firmware update was provided. As such, the firmware update activation confirmation receiving operations 1000 that cause the method 300 to proceed to block 314 from decision block 312 may include receiving a respective firmware update activation confirmation from all of the CXL memory device to which the firmware update was provided.

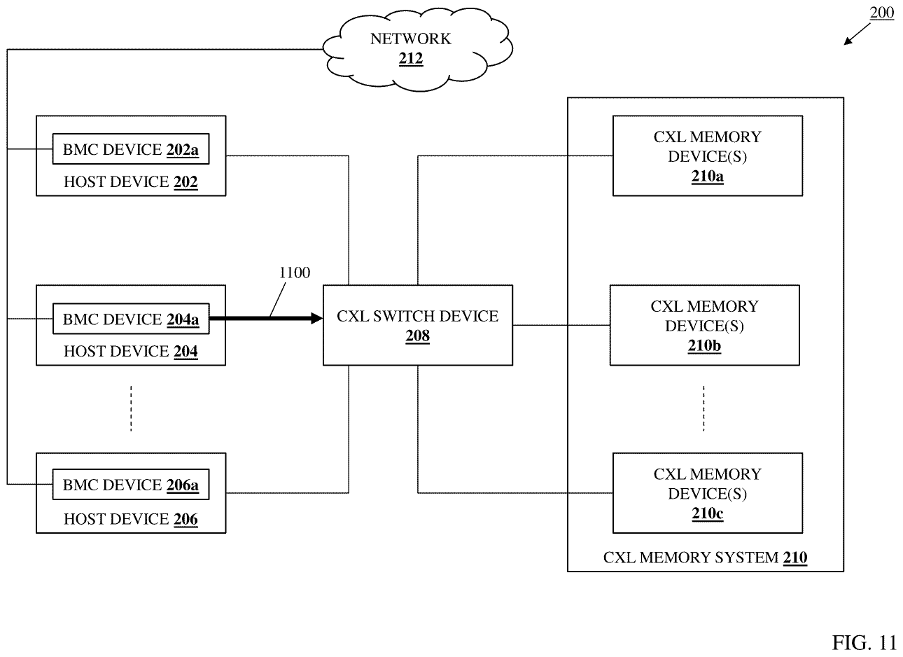

With reference to FIG. 11, in an embodiment of block 314 and continuing the example illustrated and discussed above with reference to FIGS. 4 and 8B, the BMC device 204a in the host device 204 (which in this example was configured as the master firmware update host to configure the host device 204 as the master host device) may perform CXL switch device configuration restore instruction operations 1100 that include generating and transmitting a configuration restore instruction to the CXL switch device 208 to restore the configuration of the subset of CXL memory devices 210a and 210c that are configured for use by the host device 204 to being configured for use by the host devices 202 and/or 206.

In this specific example, the subset of CXL memory devices for which the firmware update was provided were configured for use by the host device 204 to perform that firmware update, and thus at block 314 the CXL switch device configuration restore instruction operations 110 include generating and transmitting a configuration restore instruction to the CXL switch device 208 to restore the configuration of that subset of CXL memory devices 210a and 210c to being configured for use by the host devices 202 and 206. As such, the configuration restore instruction may include an instruction to restore the configuration of the one or more of the CXL memory device(s) 210a (and in some cases, all of the CXL memory device(s) 210a) for which the firmware update was provided from being configured for use by the host device 204 to being configured for use by the host device 202, and to restore the configuration of the one or more of the CXL memory device(s) 210c (and in some cases, all of the CXL memory device(s) 210c) for which the firmware update was provided from being configured for use by the host device 202 to being configured for use by the host device 206.

However, while a specific example has been provided in which the configuration restore instruction includes an instruction to restore the configuration of the one or more of the CXL memory device(s) 210a and the one or more of the CXL memory device(s) 210c, one of skill in the art in possession of the present disclosure will appreciate how the configuration restore instruction may only include an instruction to restore the configuration of the one or more of the CXL memory device(s) 210a, or may only include an instruction to restore the configuration of the one or more of the CXL memory device(s) 210c, while remaining within the scope of the present disclosure. In other words, the configuration restore instruction will instruct the CXL switch device 208 to restore the configuration of any CXL memory devices that 1) are currently configured for use by the host device 204 in updating their firmware, and 2) were initially configured for use by the host device 202 or 206 prior to having their firmware updated.

With reference back to FIGS. 4 and 8B, in an embodiment of block 314 and in response to receiving the configuration restore instruction, the CXL switch device 208 may perform CXL memory device configuration restore operations that include restoring the configuration of the subset of CXL memory devices 210a and 210c that had their firmware updated such that they are available for use by the host device 202 or 206 that was initially configured to use them prior to the firmware update. As such, the subset of CXL memory devices for which a firmware update was provided may include one or more of the CXL memory devices 210a and one or more of the CXL memory devices 210c, and the configuration restore operations may include the CXL switch device 208 reconfiguring itself by disconnecting the communication link 800 between the host device 204 and the CXL memory device(s) 210a and providing the communication link 400 between the host device 202 and those one or more CXL memory devices 210c, and disconnecting the communication link 802 between the host device 204 and the CXL memory device(s) 210c and providing the communication link 404 between the host device 206 and those one or more CXL memory devices 210c.

As such, the configuration restore operations may include restoring the configuration of the one or more of the CXL memory device(s) 210a (and in some cases, all of the CXL memory device(s) 210a) for which the firmware update was provided from being configured for use by the host device 204 to being configured for use by the host device 202, and restoring the configuration of the one or more of the CXL memory device(s) 210c (and in some cases, all of the CXL memory device(s) 210c) for which the firmware update was provided from being configured for use by the host device 204 to being configured for use by the host device 206.

Similarly as described above, while a specific example has been provided in which one or more of the CXL memory device(s) 210a and one or more of the CXL memory device(s) 210c have their configuration restored such that they may be used by the host devices 202 and 206, respectively, one of skill in the art in possession of the present disclosure will appreciate how the configuration restore may only be performed for one or more of the CXL memory device(s) 210a, or may only be performed for one or more of the CXL memory device(s) 210c, while remaining within the scope of the present disclosure. In other words, the CXL switch device 208 will restore the configuration of any CXL memory devices for use by the host device 202 or 206 that 1) were configured for use by host device 204 for the purposes of updating their firmware, and 2) for which a firmware update has been provided.

As such, following block 314 and in the specific example illustrated in FIG. 4, the host device 202 includes the communication link 400 to the CXL memory device(s) 210a, the host device 204 includes the communication link 402 to the CXL memory device(s) 210b, and the host device 206 includes the communication link 404 to the CXL memory device(s) 210c, and each host device 202, 204, and 206 may subsequently utilize its CXL memory device(s) 210a, 210b, and 210c, respectively, for any of a variety of conventional CXL memory device uses that would be apparent to one of skill in the art in possession of the present disclosure. Furthermore, while a specific example has been provided, one of skill in the art in possession of the present disclosure will appreciate how any CXL memory device that was reconfigured for use by the master host device for the purposes of updating its firmware may have its initial configuration that enabled use by another host device restored at block 314 while remaining within the scope of the present disclosure as well.

As discussed above, in some examples the BMC device 204a may perform the CXL memory device firmware update operations 900 at block 310 during a designated maintenance time period in which the CXL memory devices 210a-210c are not in use by the host devices 202-206, and thus the CXL switch device 208 may reconfigure the subset of the CXL memory device(s) for use by the host device 204 at block 308, followed by the BMC device 204a providing the firmware update on the subset of CXL memory devices at block 310, during that designated maintenance time period.

As also discussed above, in other examples the BMC device 204a may perform the CXL memory device firmware update operations 900 at block 310 in between periods of use of the subset of the CXL memory devices by the host devices (e.g., a “live” firmware update). For example, the CXL switch device 208 may reconfigure the subset of the CXL memory device(s) for use by the host device 204 for a first time period, followed by the BMC device 204a providing a portion of the firmware update on the subset of CXL memory devices during that first time period, followed by the CXL switch device 208 restoring the configuration of at least some of the subset of the CXL memory device(s) for use by the host devices 202 and 206 at the end of that first time period. The CXL switch device 208 may then subsequently reconfigure the subset of the CXL memory device(s) for use by the host device 204 for a second time period, followed by the BMC device 204a providing a portion of the firmware update on the subset of CXL memory devices during that second time period, followed by the CXL switch device 208 restoring the configuration of at least some of the subset of the CXL memory device(s) for use by the host devices 202 and 206 at the end of that second time period, and this process may be repeated for as many time periods as are needed to provide the firmware update on the CXL memory devices.

Thus, systems and methods have been described that provide for the updating of firmware on CXL memory devices via a master host device that is one of a plurality of host devices that are configured to use those CXL memory devices. For example, the CXL memory device firmware update system of the present disclosure may include a CXL switch device that configures a first host device and second host devices to use CXL memory devices. The first host device identifies firmware used by each of the CXL memory devices and, in response, identifies a firmware update for a subset of the CXL memory devices. The first host device then instructs the CXL switch device to reconfigure the subset of the CXL memory devices that are configured for use by second host device(s) to being configured for use by the first host device to provide the firmware update on the subset of the CXL memory devices. The first host device then receives firmware update activation confirmations from the subset of the CXL memory devices and, in response, instructs the CXL switch device to restore configuration of the subset of the CXL memory devices for use by the second host device(s). As such, the CXL memory device firmware update system of the present disclosure allows firmware on CXL memory devices to be updated without the redundant performance of the same firmware update operations by different host devices, eliminates security issues present in conventional CXL memory device firmware update systems, reduces downtime needed to perform CXL memory device firmware updates, and prevents firmware inconsistencies that can lead to degraded performance and/or other performance issues, communication errors and/or other compatibility issues, inconsistent CXL memory device behavior, CXL memory system instabilities, and/or other operational challenges.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Compute eXpress Logic (CXL) memory device firmware update system, comprising:
a first host device;
a plurality of second host devices;
a plurality of Compute eXpress Logic (CXL) memory devices; and
a CXL switch device that configures the first host device and each of the plurality of second host devices to use the plurality of CXL memory devices, wherein the first host device is configured to:
identify respective firmware used by each of the plurality of CXL memory devices;
identify, based on the respective firmware used by each of the plurality of CXL memory devices, a firmware update for a subset of the plurality of CXL memory devices;
instruct the CXL switch device to reconfigure the subset of the plurality of CXL memory devices that are configured for use by at least one of the plurality of second host devices to being configured for use by the first host device;
provide, in response to the CXL switch device reconfiguring the subset of the plurality of CXL memory devices that are configured for use by at least one of the plurality of second host devices to being configured for use by the first host device, the firmware update on the subset of the plurality of CXL memory devices; and
receive, from each of the subset of the plurality of CXL memory devices, a firmware update activation confirmation and, in response, instruct the CXL switch device to restore configuration of the subset of the plurality of CXL memory devices for use by the at least one of the plurality of second host devices.

2. The system of claim 1, wherein the first host device is configured as a master firmware update host for a plurality of host devices that include the first host device and the plurality of second host devices.

3. The system of claim 1, wherein the first host device is configured to provide the firmware update on the subset of the plurality of CXL memory devices using Peripheral Component Interconnect express (PCIe) Vendor Defined Messages (VDMs).

4. The system of claim 1, wherein the first host device is configured to provide the firmware update on the subset of the plurality of CXL memory devices during a designated maintenance time period.

5. The system of claim 1, wherein the first host device is configured to provide the firmware update on the subset of the plurality of CXL memory devices in between periods of use of the subset of the plurality of CXL memory devices by the at least one of the plurality of second host devices.

6. The system of claim 1, wherein each of the subset of the plurality of CXL memory devices are provided by the same CXL memory device provider.

7. An Information Handling System (IHS), comprising:
a processing system; and
a memory system that is coupled to the processing system and that includes instructions that, when executed by the processing system, cause the processing system to provide a management engine that is configured to:
identify respective firmware used by each of a plurality of Compute eXpress Logic (CXL) memory devices that are coupled to the processing system via a CXL switch device that configures the IHS and each of a plurality of host devices to use the plurality of CXL memory devices;
identify, based on the respective firmware used by each of the plurality of CXL memory devices, a firmware update for a subset of the plurality of CXL memory devices;
instruct the CXL switch device to reconfigure the subset of the plurality of CXL memory devices that are configured for use by at least one of the plurality of host devices to being configured for use by the IHS;
provide, in response to the CXL switch device reconfiguring the subset of the plurality of CXL memory devices that are configured for use by at least one of the plurality of host devices to being configured for use by the IHS, the firmware update on the subset of the plurality of CXL memory devices; and
receive, from each of the subset of the plurality of CXL memory devices, a firmware update activation confirmation and, in response, instruct the CXL switch device to restore configuration of the subset of the plurality of CXL memory devices for use by the at least one of the plurality of host devices.

8. The IHS of claim 7, wherein the IHS is configured as a master firmware update host for the IHS and the plurality of host devices.

9. The IHS of claim 7, wherein the IHS is configured to provide the firmware update on the subset of the plurality of CXL memory devices using Peripheral Component Interconnect express (PCIe) Vendor Defined Messages (VDMs).

10. The IHS of claim 7, wherein the IHS is configured to provide the firmware update on the subset of the plurality of CXL memory devices during a designated maintenance time period.

11. The IHS of claim 7, wherein the IHS is configured to provide the firmware update on the subset of the plurality of CXL memory devices in between periods of use of the subset of the plurality of CXL memory devices by the at least one of the plurality of host devices.

12. The IHS of claim 7, wherein each of the subset of the plurality of CXL memory devices are provided by the same CXL memory device provider.

13. The IHS of claim 12, wherein the identifying the firmware update for the subset of the plurality of CXL memory devices includes retrieving the firmware update from the same CXL memory device provider.

14. A method for updating firmware for Compute eXpress Logic (CXL) memory devices, comprising:
identifying, by a first host device, respective firmware used by each of a plurality of Compute eXpress Logic (CXL) memory devices that are coupled to the first host device via a CXL switch device that configures the first host device and each of a plurality of second host devices to use the plurality of CXL memory devices;
identifying, by the first host device based on the respective firmware used by each of the plurality of CXL memory devices, a firmware update for a subset of the plurality of CXL memory devices;
instructing, by the first host device, the CXL switch device to reconfigure the subset of the plurality of CXL memory devices that are configured for use by at least one of the plurality of second host devices to being configured for use by the first host device;
providing, by the first host device in response to the CXL switch device reconfiguring the subset of the plurality of CXL memory devices that are configured for use by at least one of the plurality of second host devices to being configured for use by the first host device, the firmware update on the subset of the plurality of CXL memory devices; and
receiving, by the first host device from each of the subset of the plurality of CXL memory devices, a firmware update activation confirmation and, in response, instructing the CXL switch device to restore configuration of the subset of the plurality of CXL memory devices for use by the at least one of the plurality of second host devices.

15. The method of claim 14, wherein the first host device is configured as a master firmware update host for a plurality of host devices that include the first host device and the plurality of second host devices.

16. The method of claim 14, wherein the first host device is configured to provide the firmware update on the subset of the plurality of CXL memory devices using Peripheral Component Interconnect express (PCIe) Vendor Defined Messages (VDMs).

17. The method of claim 14, wherein the first host device is configured to provide the firmware update on the subset of the plurality of CXL memory devices during a designated maintenance time period.

18. The method of claim 14, wherein the first host device is configured to provide the firmware update on the subset of the plurality of CXL memory devices in between periods of use of the subset of the plurality of CXL memory devices by the at least one of the plurality of second host devices.

19. The method of claim 14, wherein each of the subset of the plurality of CXL memory devices are provided by the same CXL memory device provider.

20. The method of claim 19, wherein the identifying the firmware update for the subset of the plurality of CXL memory devices includes retrieving the firmware update from the same CXL memory device provider.
